(19) United States
(12) Patent Application Publication
(10) Pub. No.: US 2015/0082982 A1
(43) Pub. Date: Mar. 26, 2015

(54) Filter Element and Filter System Having a Filter Element

(71) Applicant: MANN+HUMMEL GMBH, Ludwigsburg (DE)

(72) Inventors: Klaus-Dieter Ruhland, Meckenheim (DE); Michael Kaufmann, Meckenheim (DE)

(21) Appl. No.: 14/474,790

(22) Filed: Sep. 2, 2014

(30) Foreign Application Priority Data
Sep. 2, 2013 (DE) 10 2013 014 490.6

(51) Int. Cl. F02M 35/024

(52) U.S. Cl. CPC F02M 35/02416; F02M 35/0245
USPC 95/273; 55/510

(57) ABSTRACT

The invention relates to a filter element (10), comprising a filter body (12) having a longitudinal axis (L), a first open or closed end disc (16) arranged at an end face (15), and a second end disc (18) arranged at the opposite end face (17), said second end disc (18) comprising a coupling element (24) which, when installed in a female housing (108), cooperates with a flow guide element (122) mounted on a cover (110) of the housing (108), whereby the filter element (10) is axially guided.

The invention further relates to a filter system (100) for removable installation of such a filter element (10).

### TECHNICAL FIELD

The invention relates to a filter element, in particular for use as air filter of an internal combustion engine, and a filter system for the installation of such a filter element.

### BACKGROUND

From DE 20 2009 016 500 U1, an air filter design is known in which at least one axial end disc of the filter element is provided with an alignment contour, which protrudes radially from the respective end disc. In a complementary manner thereto, the filter housing has an alignment counter-contour, which works with the alignment contour of the filter element such that the filter element can be inserted into the filter housing with respect to its longitudinal central axis exclusively in a predetermined rotational position.

In certain applications a symmetrical flow pattern downstream of the filter element can be significant in air filter systems. For example, in a fresh air system downstream of the filter element an air-flow sensor, in particular in the form of a hot film sensor, can be arranged in order to detect, for example, the currently flowing air quantity for an engine control. If for any reason it is necessary to position this air-flow sensor relatively close to the filter element, the relative rotational position of the filter element in the filter housing can have an influence on the measurement of the air-flow sensor. In order to reduce the influence of the rotational position of the filter element on the air-flow measurement, it is possible to calibrate the air-flow sensor only with an installed filter element. The required expense may still be feasible for the initial equipping of a vehicle, but becomes quite complicated or even impossible in the event the filter element is replaced during an inspection. The newly inserted filter element then regularly has a different relative rotational position with respect to the filter housing and therefore also with respect to the air-flow sensor, which makes a renewed calibration of the air-flow sensor necessary. The expenditure for this is comparatively high and can, in particular, exceed the material costs for the new filter element and the labor costs for the exchange of the filter element.

### SUMMARY OF THE INVENTION

An object of the invention is to provide a filter element that allows for repeatable mountability in a simple manner.

Another object of the invention is to provide a filter system for the mounting of such a replaceable filter element that allows for repeatable mountability in a simple manner.

The above-mentioned objects are solved according to one aspect of the invention by a filter element, wherein a second end disc comprises a coupling element which, when installed in a female housing, cooperates with a flow guide element attached to a cover of the housing, whereby the filter element is axially guided.

Advantageous embodiments and advantages of the invention will become apparent from the further claims, the description and the drawing.

A filter element is proposed, comprising a filter body having a longitudinal axis, a first open or closed end disc arranged on an end face and a second end disc arranged on the opposite end face. In this case, the second end disc comprises a coupling element, which, when installed in a female housing, cooperates with a flow guide element attached to a cover of the housing, whereby the filter element is axially guided.

Advantageous is that not only repeatable mountability of the filter element, but also increased filter efficiency is allowed in a simple manner.

The filter element, the filter body of which has an intended permeable design for the medium to be filtered and which is closed at both ends by end discs, of which one end disc is generally impermeable to the medium to be filtered, is advantageously disposed in a filter system such that the medium to be filtered, for example dust-laden air, passes through an inlet into the housing and is tangentially directed past the filter element. Due to the tangential inflow of the filter element, the flow is placed in a rotating movement around the filter element, a so-called cyclonic motion. In this cyclonic pre-separation, the rotation of the flow causes centrifugal forces to be applied to any coarser dust and dirt particles in the air, which can thereby be pre-separated to a large extent. The flow guide element can be configured here as a hollow cylindrical frame enclosing the filter element and arranged in the cover, which facilitates the pre-separation of coarser dust and dirt particles by means of the cyclonic effect through suitable flow guidance, since it directs the medium to be filtered in a rotational motion around the filter body.

During installation in the housing of the filter system, the filter element with its coupling element can be guided in a specific position into a centering element mounted in the flow guide element, and in this way is always mounted in the same position when closing the cover on the housing. The coupling element can be configured for example as a tab on the end disc. The coupling element may advantageously be dimensioned at least 5%, especially between 5% and 10% of the diameter of the end disc, in order to constitute a stable and robust structure and to protrude in a radial direction beyond the circumference of the end disc.

The coupling element thus represents an anti-rotation element of the filter element. This means that the filter body of the filter element is also always positioned in the same position in the filter system. Filter bodies typically have a seam where the filter medium, for example paper bellows, is glued or welded to form a cylinder. This seam section is usually not permeable to the medium to be filtered. Owing to this, the filter body is not rotationally symmetrical in its flow properties with respect to its longitudinal axis, which in turn means that the pressure loss through the filter body and hence the signal from a connected airflow sensor which controls the combustion process of a downstream internal combustion engine, may be dependent on the installation position of the filter body. When high demands are placed on the measurement accuracy of the airflow sensor, this can be a problem. If the filter element and thus the filter body can only be mounted in one position in the filter system, this source of error can be eliminated. Since the coupling element is advantageously mounted on a dirt outlet of the housing of the filter system, it may further perform a flow control function for the medium to be filtered, since the flow can better follow the desired cyclonic motion such that coarse dirt particles, which are pre-separated by the cyclonic effect at the inner wall of the housing, can practically be conducted into the dirt outlet. The coupling element, in cooperation with the flow guide element, thereby exercises a flow control function for the medium to be filtered.

In this manner, the pre-separation efficiency of the filter system can be increased. Further, through this control geometry integrated in an end disc of the filter element, it is possible to increase the overall filter efficiency with respect to suction vacuum, pre-separation efficiency and initial pressure loss by suitable shaping of the coupling element. Compared with the prior art, where no flow control function is exercised in the dust discharge area, this is a distinct advantage.

In order to represent an advantageous mounting option, the flow guide element may have a slot structure for inserting the coupling element. This allows the filter element with the coupling element to be simply inserted in the slot structure of the flow guide element and can then be inserted with the cover into the housing of the filter system. In this way, after closing the cover the filter element is always mounted in a specific position relative to the housing in the same position in the housing. The slot structure may advantageously be configured as a continuous slot in the axial direction of the flow guide element. The width of the slit may preferably be at least 2%, especially between 2% and 5% larger than the width of the coupling element, so that the filter element with the coupling element can be readily guided into the slot structure. The slot structure can be expediently arranged in the cover so that it is spatially positioned over the dirt outlet when the filter body is closed, in order to effectively discharge the dust particles separated via the cyclonic effect at this point. For this purpose, the slot structure is preferably arranged in the same angle position as the dirt outlet. With this arrangement of the slot structure, the coupling element can also advantageously exert its favorable effect on the flow for discharging the separated dust particles.

The coupling element can advantageously be formed integrally with the second end disc. A very expedient option is for instance to mold the coupling element in a single operation with the end disc. In this manner, moreover, a fixed connection to the end disc is automatically brought about and can be intuitively mounted in the flow guiding element, for example in a slot structure.

In another embodiment, the coupling element may be integrally molded on the second end disc. For manufacturing reasons, it may also be advantageous to use the second end disc for other filter elements as well, and consequently to manufacture the coupling element in a separate process and affix it to the end disc, which in turn can also be performed by means of an injection molding process.

In a favorable embodiment, the filter body may for example consist of a filter bellows folded in a zigzag shape (pleated) and be formed as a closed ring. The folding may be performed, for example, by means of knife pleating, for longer filter bodies, or rotational folding. The filter bellows may consist for example of paper or cellulose, or a mixed fiber made of plastic and cellulose. The filter bellows may further be formed with a smooth surface, rolled and/or with a surface shaped with various impression molds for stiffening and/or creation of cavities for the deposition of dust. The filter bellows may have a coating and/or impregnation to reject moisture. It may alternatively be coated with nanofibers. The filter body may further be structurally reinforced with a spiral wound glue strip. The use of these materials as a filter medium is a very economical way to realize such a filter element. At the same time, the above form design provides a stable arrangement, so that a self-supporting structure of the filter body and thus favorable mounting characteristics are given.

Advantageously, the filter element can be used as an air filter, in particular as an air filter of an internal combustion engine. The safe operation of internal combustion engines is also based on a secure and low-cost filtering of the intake air for the combustion operation. The filter element described provides an economical way to do so.

Advantageous is also the use of the filter element as a particle filter, in particular a particle filter of an internal combustion engine. Again, the safe installation and expedient replaceability of the described filter element is crucial.

According to another aspect, the invention relates to a filter system having a filter element according to the invention, comprising a housing, which is constructed substantially concentrically about a longitudinal axis, a cover closing the housing, which is also constructed concentrically about the longitudinal axis, an inlet arranged on the housing and/or cover for supplying the medium to be filtered, in particular air, wherein an outlet for discharging the filtered medium is arranged on the housing concentrically about the longitudinal axis, wherein a sealing contour is provided on the housing in the area of the outlet corresponding to a radial seal of the first end disc of the filter element, wherein the filter element is replaceably disposed on the housing of the filter system. The main advantage of such a filter system lies in the secure and stable mounting of the filter element as well as a very expedient replaceability of the filter element in case of service. Especially with short service lives as may occur in agricultural and construction use, rapid replaceability is vital.

Advantageously, a cyclone separator may be provided in the area of the inlet of the filter system and a dirt outlet may be provided on the housing or on the cover. This cyclone separator comprises a control geometry along which the tangential inflow of the medium to be filtered is placed in rotation. For example, the control geometry is formed by a ring-shaped wall encircling the inlet, which surrounds the filter element in the area of a preferably tangential air inlet, so that a ring-shaped flow channel is formed between the wall and the housing wall. Alternatively, the filter element may also comprise at least one fluid-tight area at its outer shell surface that is impermeable for the medium to be filtered and analogously forms a ring-shaped flow channel together with the housing wall. This may for example be formed by a film cladding situated on the shell surface that surrounds the filter body in the area of the flow inlet, for instance made of a plastic film, which is connected to the end disc of the filter element or welded thereto or molded therein. By means of this rotation in this flow channel, dirt is concentrated in the area of the housing wall and is discharged at a suitable location via a dirt outlet. Through the pre-separation of the majority of dirt from the air to be filtered, the service life of the actual filter element can be significantly extended.

According to a further embodiment of the invention, a secondary element can be arranged in the interior of the filter element. The secondary element, which may consist of a supporting structure in a cylindrical configuration which is lined with a permeable filter medium, such as a nonwoven fabric, has the task to continue to keep the outlet of the filter system closed when replacing the filter element so that no dirt can enter this area while the filter element is being cleaned or replaced. The secondary element, which may be arranged concentrically about the longitudinal axis of the filter system in the interior of the filter element, is connected with the housing for example via a screw connection and fitted to the housing with a seal.

### BRIEF DESCRIPTION OF THE DRAWINGS

Other advantages will become apparent from the following description of the drawings. In the drawings, exemplary embodiments of the invention are shown. The drawings, the description and the claims contain numerous features in combination. The person skilled in the art will expediently also consider the features individually and combine them into additional meaningful combinations.

The following is shown by way of example:

FIG. 1 a perspective view of a filter system according to one embodiment of the invention with a tangential inlet, centered outlet, and bottom-side dirt outlet;

FIG. 2 a longitudinal section through a filter system according to one embodiment of the invention;

FIG. 3 a filter element having a coupling element attached to a second end disc according to one embodiment of the invention;

FIG. 4 an interior view of a cover of a housing of a filter system according to one embodiment of the invention, in which a flow guide element is shown with a slot structure for coupling the filter element;

FIG. 5 a partial view of a filter system according to one embodiment of the invention, in which a filter element is shown which is inserted with a coupling element into a slot structure of a flow guide element that is mounted on a cover of a housing.

### DETAILED DESCRIPTION OF THE INVENTION

In the figures, identical or similar components are numbered with the same reference numerals. The figures show only examples and are not to be understood as limiting.

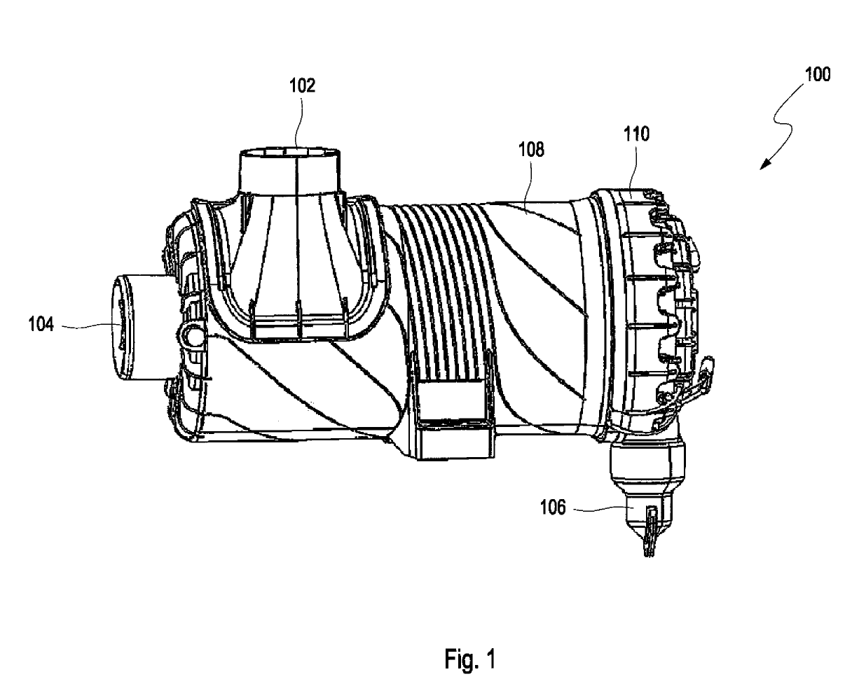

FIG. 1 shows a perspective view of a filter system 100 according to one embodiment of the invention, which may be used for example as an air filter of an internal combustion engine, with a tangential inlet 102, centered outlet 104 on a housing end face and bottom-side dirt outlet 106. Shown is a round filter design, which consists of a housing 108 that is closed with a cover 110, for example with a screw or bayonet fitting. When used as an air filter system, dust-laden air flows into the inlet 102 that is arranged tangentially to the inner-mounted element of the air filter, so that the air is placed in a rotational motion within the housing 108 by an inflow protection element at the filter element. The filter element and inflow protection element are not shown in the drawing. By means of the cyclonic effect produced by the rotational motion of the air, centrifugal forces act on the dust particles of the flowing air, so that they are partially deposited at the housing wall and can be discharged from the filter system 100 through the dirt outlet 106. In this manner, the filter element is less burdened and the service life of the filter element is extended. The cleaned air can be discharged via the centered outlet 104 of the housing 108.

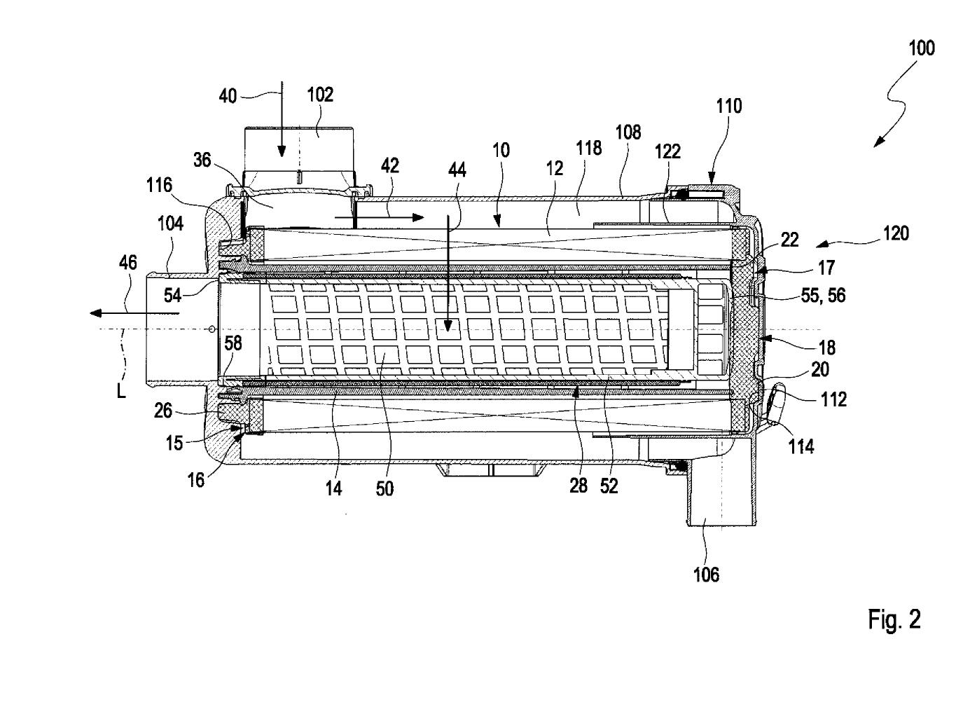

FIG. 2 shows a longitudinal section through a filter system 100 according to one embodiment of the invention with a tangential inlet 102, centered outlet 104, and bottom-side dirt outlet 106. The housing 108 of the filter system 100 is closed at the end face 120 with a cover 110. A filter element 10, which substantially consists of a filter body 12 concentric to the longitudinal axis L, is closed at two opposite end faces 15, 17 with a first open and a second end disc 16, 18, which can be formed, for example, from polyurethane foam or an elastomer. The filter body 12 may for example consist of a filter bellows folded in a zigzag shape (pleated) and be formed as a closed ring. The folding may be performed, for example, by means of knife pleating, for longer filter bodies 12, or rotational folding. The filter bellows may, for example, be made of paper, cellulose, or a mixed fiber made of plastic and cellulose and formed with a smooth surface, rolled and/or with a surface shaped with various impression molds for stiffening and/or creation of cavities for the deposition of dust. The filter bellows may have a coating and/or impregnation to reject moisture. It may alternatively be coated with nanofibers. The filter body 12 may further be structurally reinforced with a spiral wound glue strip.

The filter element 10 is inserted with a coupling element, which is not visible in the section shown, into a flow guide element 122, which is formed as a hollow cylinder and is attached to the cover 110, and thus positioned in a rotationally secure and specific position relative to the housing 108 of the filter system 100, because the cover 110 is also positioned in a specific position relative to the housing 108, for example via a bayonet fitting. In this way, the filter element 10 can always be mounted in the same position, and cannot move even in the presence of vibration, for example during the operation of an internal combustion engine.

The second end disc 18 has support knobs 20 which are arranged radially outwardly extending in a circle around the longitudinal axis L and are supported axially against the housing 108 when installed in the female housing 108 to an inner cover contour 114 of the cover 110. In the interior 50 of the filter element 10, a support tube 14 fixed to the housing is arranged concentrically about the longitudinal axis L and is connected at the outlet end of the support tube 14 to the housing 108. The surface of the second end disc 18 facing the support tube 14 is positioned on the open the end of the support tube 14 facing the end disc 18. When the inner contour 114 of the cover 110 presses against the end disc 18 during the closing of the cover 110, this force is transmitted through the end disc 18 via the support knobs 20 to the end disc 18, as it can support itself on the support tube 14. In this way, the filter element 10 is axially clamped against the cover 110 through the second end disc 18 and thus relative to the housing 108, and is thereby in a fixed position on the end face 17, the cover-side end of the filter element 10.

Furthermore, rib-shaped projections 112 are mounted in the inner cover contour 114, with which the elastic material of the second end disc 18 can interlock or mesh so that the filter element 10 is thereby secured against possible rotation in the event of vibration during operation. Furthermore, recesses 22 are also conceivable on the end of the support tube 14 facing the end disc 18, which permit a further interlocking or meshing of the support tube 14 with the end disc 18 so as to ensure further protection against rotation of the filter element 10 due to vibration.

At the opposite end face 15 of the filter element 10, a radial seal 26 is attached to the first end disc 16, which corresponds to a sealing contour 116 of the housing 108 and with the aid of which the filter element 10 seals the unfiltered from the filtered air space.

Dust-laden air can flow through the inlet 102 in the direction of arrow 40, shown in this case as a tangential inlet, and enables cyclonic operation caused by the rotational motion of the air effected by means of a cyclone separator 36. By means of the rotational motion, partially pre-separated dust particles can be deposited on the inner housing wall and discharged downward from the filter system 100 by the force of gravity through the dirt outlet 106 when the filter body 108 is installed in a horizontal position. This pre-separation takes place in an interior region 118 of the housing, preferably at the inner wall of the housing 108, in which the dust-laden air can flow freely.

During operation, the air, subsequent to the partial separation of the dust particles, flows through the filter body 12 in the direction of arrows 42, 44 into the interior 50 of the filter element. Dust particles of a specific size, depending on the filter medium, are then caught in the filter medium. Therefore, depending on the entry of dust, the filter element 10 must be replaced after a certain service life. Via the outlet 104, the filtered air flows in the direction of arrow 46.

In the interior 50 of the filter element 10, a secondary element 28 is attached, which essentially consists of a supporting structure, the body 52 having a relatively permeable filter medium, such as a nonwoven fabric, and which remains in the housing 108 when replacing the filter element 10 to protect the further air flow, for example, of an internal combustion engine, against the ingress of dust particles and other objects. The secondary element 28 is inserted with the open end 54 into a housing seat 58 on the outlet side of the housing 108. On the closed end 55 of the secondary element 28, the second end disc 18 of the filter element 10 is situated, whereby when closing the housing cover 110, force may be directed via the support knobs 20 of the end disc 18 to the closed end 55 of the secondary element 28, which is configured as a handle 56 and with which it can be removed from the housing seat 58 and therefore the housing 108, thus firmly pressing the secondary element 28 into its housing seat 58.

Filter systems such as those shown in FIGS. 1 and 2 are commonly used in the construction machinery and agricultural machinery sectors. They are characterized by great robustness and have short service lives due to the high load on the filter. A filter system with loaded filter element must be able to tolerate a weight gain of 10 kg or more.

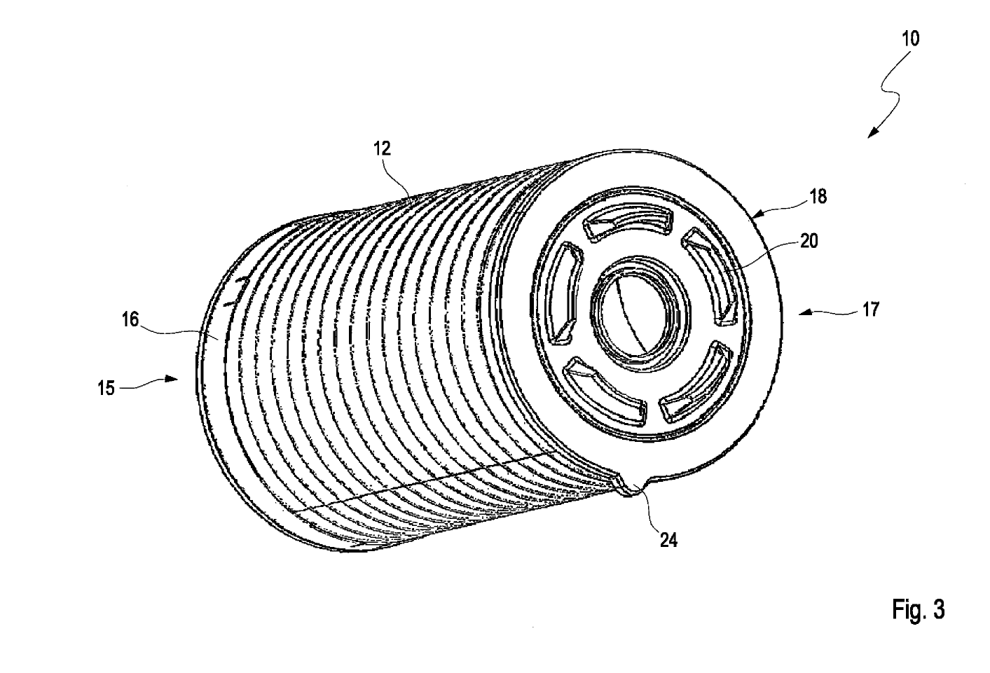

FIG. 3 shows a filter element 10 having a coupling element 24 attached to a second end disc 18 according to one embodiment of the invention; The filter element 10 consists of a filter body 12 which is closed at the two end faces 15, 17 by the end discs 16, 18. The second end disc 18 has support knobs 20 at the top for axial and radial clamping in a housing when the filter element 10 is inserted and the housing is closed from the outside by a cover, on which the filter element 10 with the support knobs 20 can interlock and mesh with the end disc 18. The coupling element 24 is shown in FIG. 3 as an integral part of the end disc 18, and has therefore, for example, been produced in one piece with the end disc 18 in an injection molding process. However, the coupling element 24 may also be injection molded or attached to the end disc 18 in a separate step. It may also very well be of another material than the end disc 18; for example, it may be advantageous if it is made from highly resistant material. The coupling element 24 may be configured as shown as a tab on the end disc 18. The coupling element 24 may advantageously be dimensioned approximately 5% to 10% of the diameter of the end disc 18, in order to constitute a stable and robust structure and to protrude in a radial direction beyond the circumference of the end disc 18.

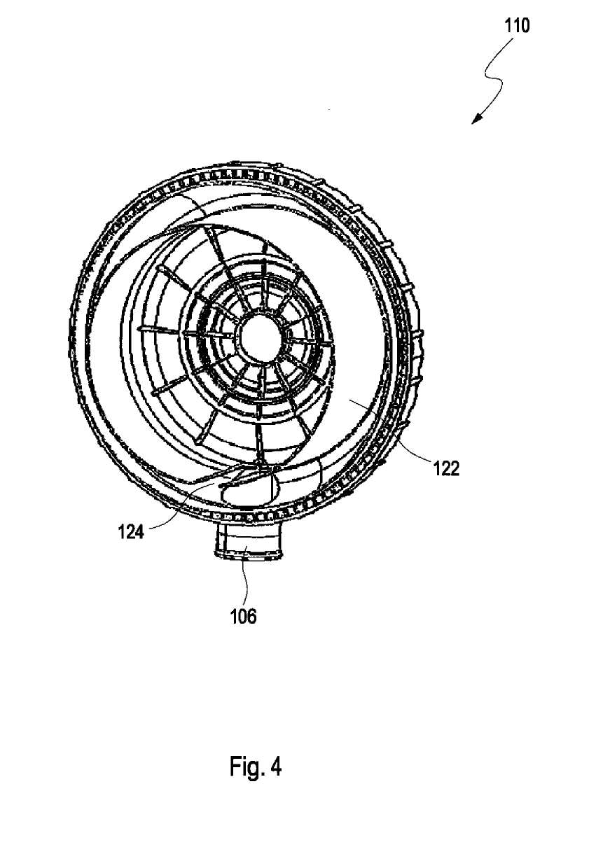

FIG. 4 shows an interior view of a cover 110 of a housing of a filter system according to one embodiment of the invention, in which a slot structure 124 in a flow guide element 122 is shown for guiding a coupling element of a filter element; In the interior view, a flow guide element 122 configured as a hollow cylindrical frame can be seen, which constitutes part of the cover 110 and includes a slot structure 124 that is used for inserting a coupling element of a filter element, and thus also as an anti-rotation element of the filter element during operation of the filter system for example in a motor vehicle, where by nature vibrations occur. On one side of the cover 110, the dirt outlet 106 mounted there can be seen. The flow guide element 122 is configured here as a hollow cylindrical frame enclosing the filter element 10 and arranged in the cover 110, which facilitates the pre-separation of coarser dust and dirt particles by means of the cyclonic effect through suitable flow guidance, since it directs the medium to be filtered in a rotational motion around the filter body 12. The slot structure 124 may advantageously be configured as a continuous slot in the axial direction of the flow guide element 122. The width of the slit may for instance be between 2% and 5% larger than the width of the coupling element 24, so that the filter element 10 with the coupling element 24 can be readily guided into the slot structure 124. The slot structure 124 is expediently arranged in the cover 110 so that it is positioned over the dirt outlet 106 when the filter body 108 is closed, in order to effectively discharge the dust particles separated via the cyclonic effect at this point. With this arrangement of the slot structure 124, the coupling element 24 can also advantageously exert its favorable effect on the flow for discharging the separated dust particles.

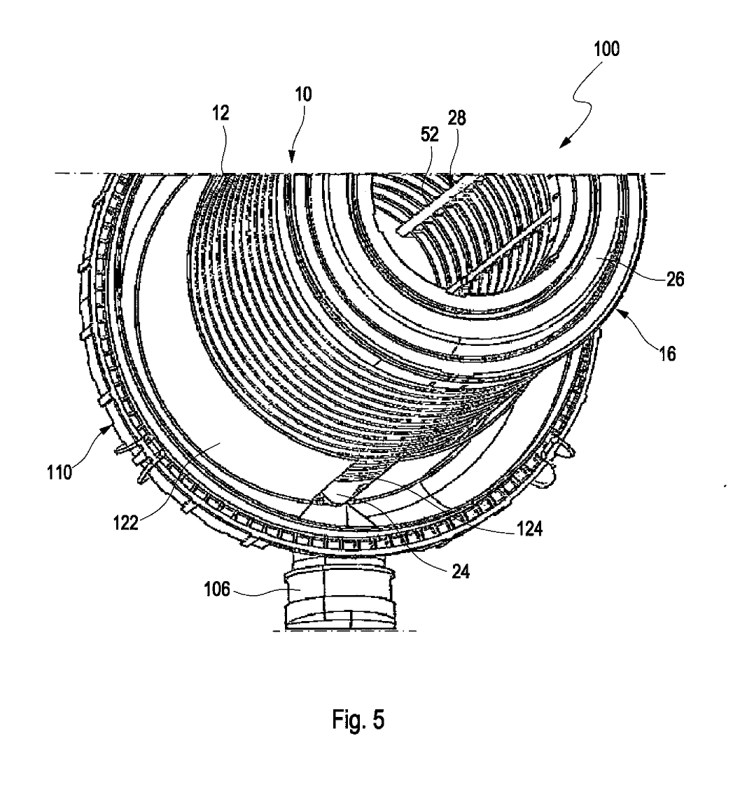

FIG. 5 shows a partial view of a filter system 100 according to one embodiment of the invention, in which a filter element 10 is shown which is inserted with a coupling element 24 into a slot structure 124 of the flow guide element 122 which is attached to a cover 110 of a housing. The filter element 10, on which a filter body 12 and an attached first end disc 16 with a radial seal 26 can be seen, is inserted into a frame attached to the cover 110 as a flow guide element 122, whereby the coupling element 24 is guided into the slotted structure 124 and thus the filter element 10 is centered in this manner. This arrangement simultaneously serves to protect the filter element from rotation during the operation of the filter system, during which substantial vibrational loads may occur due to the flow effect of the medium to be filtered as well as vibration caused by internal combustion engines to which the filtering system 100 is connected. On the bottom side of the cover 110, a dirt outlet 106 can be seen. The coupling element 24, in cooperation with the flow guide element 122, can exert a flow control function on the medium to be filtered, since the flow of the medium to be filtered is placed in a cyclonic movement between the housing wall and the flow guide element 122. In this cyclonic pre-separation, coarser dirt particles in the flow are deposited at the inner housing wall and can thus be guided by the flow through the coupling element 24, which is mounted directly over the dirt outlet 106, into the dirt outlet 106. A further advantage of this flow control function is the slot structure 124 that is similarly mounted above the dirt outlet 106, since the slot structure 124 is permeable for the medium to be filtered and the flow is therefore preferably guided into the filter body 12 at this point, while heavier dirt particles may fall into the dirt outlet 106 along the housing inner wall due to the cyclonic effect.

1. A filter element (10), comprising
a filter body (12) having a longitudinal axis (L),
a first open or closed end disc (16) arranged at an end face (15), and
a second end disc (18) arranged at the opposite end face (17), said second end disc (18) comprising
a coupling element (24) which, when installed in a female housing (108), cooperates with a flow guide element (122) mounted on a cover (110) of the housing (108), whereby the filter element (10) is axially guided.

2. The filter element according to claim 1, wherein
the coupling element (24) forms an anti-rotation element of the filter element (10).

3. The filter element according to claim 1, wherein
the coupling element (24) exerts a flow control function for the flow medium to be filtered in cooperation with the flow guide element (122).

4. The filter element according to claim 3, wherein
the coupling element (24), in cooperation with the flow guide element (122), effects a flow guide of the medium to be filtered to a dirt outlet (106) of the housing (108).

5. The filter element according to claim 1, wherein
the coupling element (24) is formed integrally with the second end disc (18) and/or injection molded onto it.

6. The filter element according to claim 1, wherein
the filter body (12) is folded in a zigzag shape, formed as a closed ring, and is preferably made of paper or cellulose, or of a mixed fiber made of plastic and cellulose.

7. A use of a filter element according to claim 1 as an air filter of an internal combustion engine.

8. A filtering system (100) having a filter element (10) according to claim 1, comprising
a housing (108), which is constructed substantially concentrically about a longitudinal axis (L),
a cover (110) closing the housing (108), which is also constructed concentrically about the longitudinal axis (L),
an inlet (102) arranged on the housing (108) and/or cover (110) for supplying the medium to be filtered, in particular air,
wherein an outlet (104) for discharging the filtered medium is arranged on the housing (108) concentrically about the longitudinal axis (L), wherein a sealing contour (116) is provided on the housing (108) in the area of the outlet (104) corresponding to a radial seal (26) of the first end disc (16) of the filter element (10),
wherein the filter element (10) is replaceably disposed on the housing (108) of the filter system (100).

9. The filter system according to claim 8, wherein
a cyclone separator (36) is provided in the area of the inlet (102) and a dirt outlet (106) is provided on the housing (108) or on the cover (110).

10. The filter system according to claim 8, wherein
a flow guide element (122) is provided at the housing portion (108, 110) opposite to the inlet (102), in particular with a slot structure (124) for inserting the coupling element (24).

11. The filter system according to claim 10, wherein
the slot structure (124) is arranged in the same angle position as the dirt outlet (106).
